(19) United States
(12) Patent Application Publication
(10) Pub. No.: US 2005/0153824 A1
(43) Pub. Date: Jul. 14, 2005

(54) Fluorine-doped silicate glass and use thereof

(76) Inventors: Jochen Alkemper, Klein-Winternheim (DE); Joerg Schuhmacher, Kornwestheim (DE); Ulrich Peuchert, Bodenheim (DE)

Correspondence Address: HARNESS, DICKEY & PIERCE, P.L.C., P.O. BOX 828, BLOOMFIELD HILLS, MI, 48303, US

(21) Appl. No.: 11/013,103

(22) Filed: Dec. 15, 2004

(30) Foreign Application Priority Data
Dec. 18, 2003 (DE) 103 61 331.5

(51) Int. Cl. C03C 3/112

(52) U.S. Cl. 501/57; 501/58; 501/59

(57) ABSTRACT

A fluorine-doped at least ternary silicate glass is disclosed which contains in particular TiO₂. It can advantageously be used as a material having a low thermal expansion, wherein the slope of the coefficient of thermal expansion dCTE/T is ±2·10⁹/K² in the temperature range from −50° C. to 100° C. This material is particularly suited for micro-lithography, in particular for EUV-lithography.

### BACKGROUND OF THE INVENTION

The invention relates to a silicate glass doped with fluorine, in particular to a titanium silicate glass, and to the utilization of such a glass as a material having an optimized thermal expansion characteristic.

Materials having low or extremely low thermal expansion play a dominant role in many branches of technology. For instance, they may be utilized as a substrate or as mechanical constructions in precision optics. Known for its low thermal expansion is, e.g., silica glass having a coefficient of thermal expansion (CTE) of about 500·10⁹/K (ppb/K) in the range from 0°C. to 50° C.

Although the average and the instantaneous coefficient of thermal expansion CTE of silica glass is relatively small when compared to ordinary multiple component glasses, the instantaneous coefficient of thermal expansion CTE is still considerably temperature-dependent. E.g., the instantaneous CTE at −50° C. is about 300 ppb/K, while it is about 600 ppb/K at +100° C.

Binary silicate glasses based on silica glass partially have a still smaller thermal expansion. From JP 64-33030, a binary silicate glass is known which is doped with ZrO₂ and which has a coefficient of thermal expansion CTE which is supposed to be about a tenth of the CTE of silica glass. Also a titanium-doped silicate glass known as a NZTE (near zero thermal expansion) material is known having a coefficient of thermal expansion of <<100 ppb/K (cf. U.S. Pat. No. 2,326,059; WO 02/088035 A1 and P. C. Schultz, H. T. Smyth: “Ultra-Low-Expansion Glasses and Their Structure in the SiO₂—TiO₂ System” in R. W. Douglas, B. Ellis (editor), Amorphous Materials, pages 453-461, Wiley, London, 1972) and has been marketed since a long time. Also this material shows a large temperature dependence of the coefficient of thermal expansion. E.g. in the range between 0 and 50° C., the slope of the CTE curve is about 1 to 2 ppb/K².

From U.S. Pat. No. 3,498,876 copper zinc aluminum silicate glasses of the system Cu₂O—CuO—ZnO—Al₂O₃—SiO₂ are known that shall have a low coefficient of thermal expansion of 15·10⁻⁷/K at the most.

Although in many applications the temperature dependence of the coefficient of thermal expansion mentioned above is not detrimental, it offers a disadvantage, in particular with some of the latest technologies. E.g. in micro-lithography, in particular in the EUV-lithography, the coefficient of thermal expansion is specified precisely and, apart from its absolute value, also the temperature dependence is of importance, since it renders more difficult the simulation and compensation of thermal effects, or even makes it impossible.

In the prior art, a decrease of the coefficient of thermal expansion of silica glass by the addition of fluorine (in the range of 2 wt.-%) in a temperature range close to room temperature has been reported several times with respect to binary glasses (cf. I. M. Rabinovich: “On the Structural Role of Fluorine in Silicate Glasses”, Phys. Chem. Glasses 24 (1983), pages 54-56; C. M. Smith, L. A. Moore: “Fused Silica for 157 nm Transmittance”, Proc. SPIE-INT. Soc. Opt. Eng. 3676 (1999), pages 834-841; K. Rau et al.: “Characteristics of Fluorine Doped Glasses”, Topical Meet. Optical Fiber Transmission II. Williamsburg (1977); H. Takahashi et al.: “Characteristics of Fluorine-Doped Silica Glass”, Technical Digest: European Conference on Optical Communication (1986), pages 3-6). In particular, the effect has been pointed out to be advantageous for the use of fluorine-doped silica glass as a substrate material for photo masks in the 157 nm lithography, since a nm lithography, since a reduced thermal expansion lowers the risk of imaging defects which are caused by temperature variations that can never be totally avoided.

On the other hand, it is known that the additional fluorine usually leads to a loosening of the glass network and, thus, to an increase of the CTE (Scholze, Horst, “Glas-Natur, Struktur und Eigenschaften, Springer Verlag, 3^{rd} edition).

### SUMMARY OF THE INVENTION

Thus, it is a first object of the invention to provide a material that is particularly suited as a substrate material in micro-lithography, in particular in EUV-lithography.

It is a second object of the invention to disclose a material having a relatively constant change of CTE over temperature.

It is a third object of the invention or to disclose a novel use of a doped silica glass.

These and other objects of the invention are achieved by an at least ternary silicate glass doped with fluorine, in particular by a fluorine-doped titanium silicate glass, the coefficient of thermal expansion CTE of which varies at the most between 2·10⁻⁹/K² and −2·10⁻⁹/K² in the temperature between −50° C. and 100° C., and is preferably between ±1.0·10⁻⁹/K².

Although the average CTE of, e.g., a titanium-doped silicate glass is not considerably lowered in the temperature range of interest, however, surprisingly the temperature dependence of CTE is considerably smaller.

### PREFERRED EMBODIMENT OF THE INVENTION

Using a glass according to the invention which, e.g., is a ternary silica glass doped with fluorine and titanium, a considerably high stability of the coefficient of thermal expansion can be reached in particular in the temperature interval of −50 C. to 100° C. of interest. Simultaneously, also an average coefficient of thermal expansion CTE results which is <<100·10⁻⁹/K, in particular <10·10⁻⁹/K, and according to one embodiment <1·10⁻⁹/K.

Such a silicate glass can, thus, be advantageously used in EUV-lithography.

According to an advantageous development of the invention, the slope dCTE/dT of the coefficient of thermal expansion in the temperature range from −50° C. to 100° C. is negative, preferably in the range of −1.5·10⁻⁹/K²<dCTE/dT<0 and, in particular, is about −0.5·10⁻⁹/K².

Thus, the slope of the coefficient of thermal expansion of silica glass, e.g. doped with titanium and having a TiO₂ content of 6.8 wt.-%, can be adjusted to a particular target value between −1.5 ppb/K² (fluorine content: about 3 wt.-%) and 1.5 ppb/K² (fluorine content: 0) by varying the fluorine content. The main application of the silicate glass according to the invention is in the temperature range from about −50° C. to 100° C., in particular from 0 to 50° C., wherein the range from 10 to 30° C. is of particular interest. Herein the absolute value of the coefficient of thermal expansion (average coefficient of thermal expansion) CTE of fluorine-doped SiO₂—TiO₂ glass is <600·10⁻⁹/K, depending on the TiO₂ content (0<TiO₂ content<10 wt.-%)

Preferably, the doping with fluorine is at least 1 wt.-%, preferably at least 2 wt.-% of fluorine. In this range which can preferably extend up to about 5 wt.-% of fluorine, the desired constancy of the coefficient of thermal expansion is reached in the target temperature range.

Silicate glasses doped according to the invention with fluorine and possibly with additional dopants can be prepared in a basically known manner by the flame hydrolysis process (soot process), plasma process or by sol-gel-processing (cf. e.g. U.S. Pat. No. 2,326,059 for flame hydrolysis).

Preferably, additional components are added as further dopants that act as glass formers. Apart from TiO₂, also ZrO₂, V₂O₅, CuO, Al₂O₃, Ge₂O₃ and/or B₂O₃ may be included. Herein, preferably CuO is added in combination with Al₂O₃.

SiO₂ is preferably present at at least 85 wt.-%, preferably at at least 90 wt.-%.

Other glass formers may be present with at least 1 wt.-% up to 10 wt.-% at the most, wherein a content of 2 to 7 wt.-% is preferred. If TiO₂ is added, preferably up to 10 wt.-% are added at the most, preferably up to 7 wt.-%.

The sum of the additions of fluorine and further dopants preferably is 15 wt.-% at the most.

The average CTE in the temperature range T1 to T2 is defined as:

$$CTE = \frac{l2 ( T2 ) - l1 ( T1 )}{( T2 - T1 ) \cdot l1}$$

wherein 11, 12 are the lengths of the sample body at the respective temperature. For silica glass, an average CTE of about 400 ppb/K results in the range of −50 to 0° C., an average CTE of about 500 ppb/K in the range of 0 to 50° C., and of about 550 ppb/K in the range of 500 to 100° C. As a measure for the temperature dependence, the slope of the CTE(T) curve at any point or the average slope in a temperature interval is used:

$$Δ CTE / Δ T = \frac{CTE2 ( T2 ) - CTE1 ( T1 )}{T2 - T1}$$

or the first differential of CTE to the temperature can be utilized: dCTE/dT.

Thus the provision that the slope or (first) derivative of the coefficient of thermal expansion dCTE/dT in a given temperature interval of e.g. −50° C. to +100° C. or from 0° C. to 50° C. or from 10° C. to 30° C. is e.g. between 1 ppb/K² and −1 ppb/K² is to be understood such, that the derivative is within the given range over the total temperature range. Another preferred range for dCTE/dT is the interval with a minimum value of −1.5 ppb/K² up to a maximum value of 0 ppb/K² for the afore mentioned temperature ranges.

Alternatively, the average slope ΔCTE/ΔT can be used which must only be met as an average over the respective temperature range of interest.

With the at least ternary silica glass doped with fluorine, a high constancy of the derivative of the coefficient of thermal expansion is reached, wherein dCTE/dT is preferably smaller than 0.5 ppb/K² and is preferably negative.

1. A silicate glass comprising SiO₂ and at least one additional glass former, which is selected from the group formed by Ge₂O₃, Al₂O₃ and B₂O₃, the silicate glass being doped with TiO₂ and at least 2 wt.-% of fluorine, and further having a derivative of a coefficient of thermal expansion dCTE/dT which is in the range of −1,5·10⁻⁹/K²<dCTE/dT <0 in the entire temperature interval between 0° C. and 50° C.

2. The silicate glass of claim 1, which is doped with at least 1 wt.-% of fluorine.

3. The silicate glass of claim 1, which comprises at least one component which is selected from the group formed by TiO₂, ZrO₂, V₂O₅, CuO and Al₂O₃.

4. The silicate glass of claim 3, which comprises at least the components CuO and Al₂O₃.

5. The silicate glass of claim 3, which comprises 1 to 10 wt.-% of said at least one component.

6. A silicate glass comprising SiO₂ and being doped with fluorine and comprising at least one additional component, said silicate glass having a derivative of a coefficient of thermal expansion dCTE/dT which is between 2·10⁻⁹/K² and −2·10⁻⁹/K² in the entire temperature range between −50° C. and 100° C.

7. The silicate glass of claim 6 wherein said at least one additional component is a glass former.

8. The silicate glass of claim 6, wherein the derivative of the coefficient of thermal expansion dCTE/dT is negative in the temperature range from 0° C. to 50° C.

9. The silicate glass of claim 6, wherein the derivative of the coefficient of thermal expansion dCTE/dT is in the range of −1,5·10⁻⁹/K²<dCTE/dT<0.

10. The silicate glass of claim 6, which is doped with at least 1 wt.-% of fluorine.

11. The silicate glass of claim 6, which comprises at least one additional component which is selected from the group formed by TiO₂, ZrO₂, V₂O₅, CuO and Al₂O₃.

12. The silicate glass of claim 11, which comprises at least the additional components CuO and Al₂O₃.

13. The silicate glass of claim 6, which comprises at least one additional component which is selected from the group formed by Ge₂O₃, Al₂O₃ and B₂O₃.

14. The silicate glass of claim 6, which is configured as a ternary silicate glass of the system SiO₂—TiO₂—F^{-.}

15. The silicate glass of claim 6, which is configured as a quaternary silicate glass.

16. The silicate glass of claim 6, wherein the content of SiO₂ is at least 85 wt.-%.

17. The silicate glass of claim 6, which, apart from SiO₂, comprises at least 1 wt.-% of at least one additional glass former.

18. A silicate glass comprising SiO₂ and at least one additional component which is selected from the group formed by TiO₂, Ge₂O₃, Al₂O₃ and B₂O₃, the silicate glass being doped with TiO₂ and at least 2 wt.-% of fluorine and further having a derivative of a coefficient of thermal expansion dCTE/dT which is in the range of −1,5·10⁻⁹/K²<dCTE/dT<0 in the entire temperature interval between 0° C. and 50° C.

19. A silicate glass comprising SiO₂ and at least one additional component, which is selected from the group formed by TiO₂, Ge₂O₃, Al₂O₃ and B₂O₃, the silicate glass being doped with TiO₂ and at least 2 wt.-% of fluorine and further having a coefficient of thermal expansion CTE the average slope of which over the temperature interval between −50° C. and 100° C. is in the range of −1,5·10⁻⁹/K²<ΔCTE/ΔT<0.

20. A silicate glass comprising SiO₂ being doped with fluorine and titanium, said silicate glass having a coefficient of thermal expansion CTE the average slope of which over the temperature interval between 0° C. and 50° C. is in the range of −1,5·10⁻⁹/K²<ΔCTE/ΔT<0.
